(19) United States
(12) Patent Application Publication
(10) Pub. No.: US 2026/0041060 A1
(43) Pub. Date: Feb. 12, 2026

(54) PET-OWNER MONITORING AND LOCATION TAG

(71) Applicant: Uddhav Joshi, Houston, TX (US)

(72) Inventor: Uddhav Joshi, Houston, TX (US)

(21) Appl. No.: 18/797,343

(22) Filed: Aug. 7, 2024

(51) Int. Cl. A01K 11/00; A01K 29/00; G06F 16/955; G08B 7/06; G08B 21/24; G08B 25/10

(52) U.S. Cl. CPC A01K 11/008; A01K 29/005; G06F 16/9554; G08B 7/06; G08B 21/24; G08B 25/10

(57) ABSTRACT

A system and method of a dependent tag connected with a smartphone or a smartwatch, that determines if a dependent (such as a pet) is unattended due to a missing or absent guardian and alerts a backup guardian. A dependent tag includes identifying information about a dependent. A communication processor is configured to receive the identifying information and a status information regarding a condition of the dependent. The communication processor is further configured to notify at least one designee after a predetermined time period has passed without receiving at least the status information.

### BACKGROUND

### Technical Field

The present disclosure generally relates to dependent identification systems, and more particularly, includes a system and method to identify lost and/or unintentionally abandoned pets.

### Description of the Related Art

Millions of pets are owned by single people (i.e. single pet parents), and/or elderly pet parents. If people living alone have some emergency (e.g. a medical emergency, storm, etc.), that prevents their return home from work or some social gathering, nobody may be aware that their pet is alone at home. In addition, if the pet is able to escape the confines of the home, or is stolen, no one, including the pet owner, may know the pet is missing until they return home. In addition, a human dependent, such as an elderly or incapacitated person, or a child, may leave the premises or require medical treatment.

### SUMMARY

Embodiments of the present disclosure provide a system and method for checking a pet's welfare and providing identification.

In one embodiment, a dependent welfare and identification system includes a dependent tag including identifying information about a dependent. A communication processor is configured to receive the identifying information and status information regarding a condition of the dependent. The communication processor is further configured to notify at least one designee after a predetermined time period has passed without receiving at least the status information.

In an embodiment, the communication processor includes a server, and wherein the identifying information and status information about the dependent is received from a mobile communication terminal.

In an embodiment, the server is configured to communicate with a host website in which the identifying information of the dependent is registered.

In an embodiment, the dependent is a pet.

In an embodiment, the owner has a separate tag (e.g., a military tag or a card). If something happens to the owner, then first responder can use their phone to scan owners QR code which will allow them to alert backup guardians for all the pets under the owner's care.

In an embodiment, the server is further configured to provide the website with status information and/or subsequent status information updates.

In an embodiment, the communication processor is a smartphone app.

In an embodiment, the communication processor generates an alert that is wireless transmitted to the at least one designee after a predetermined time period has passed without receiving at least the status information.

In an embodiment, when the at least designee totals two or more designees, the communication processor transmits the alert to the two or more designees at the same time or in succession until one of the two or more designees acknowledges receipt of the alert.

In an embodiment, the communication processor is a smartphone or smartwatch.

In an embodiment, the pet tag includes a wireless frequency transponder to communicate with the smartphone or smartwatch.

In an embodiment, the pet tag includes a transmitter configured to output information in Bluetooth or Near Frequency Communication (NFC).

In an embodiment, the identifying information is stored on the pet tag as a scannable code.

In an embodiment, the identifying information is stored on the pet tag as a QR code or

bar code.

In an embodiment, wherein the communication processor is further configured to output a pet profile to a display in response to detecting the pet tag has been scanned by a mobile communication device; receive a check-in status periodically and update a storage with the latest status information; and generate an alert to notify the at least one designee after the predetermined time period has passed without receiving at least the status information.

In an embodiment, the communication processor is smartphone or smartwatch further configured to output a pet profile to a display in response to detecting activation of a touchscreen; receive a check-in status periodically and update a storage with the latest status information; and generate an alert to notify the at least one designee after the predetermined time period has passed without receiving at least the status information.

In an embodiment, the smartphone or smartwatch generates at least one text message or one email to the at least one designee when a predetermined period time period has elapsed without receiving an update status information.

In an embodiment, the smartphone or smartwatch generates at least one audible alert, tactile alert, or visual alert as a reminder that updated status information regarding the pet has not been received.

In an embodiment, a method of providing a pet welfare and identification includes providing a pet tag including identifying information about a pet; receiving, by a communication processor, the identifying information and a status information regarding a condition of the pet, and notifying at least one designee after a predetermined time period has passed without receiving at least the status information. The providing of identification information is wirelessly transmitted by the pet tag, or the pet tag includes scannable code that is read and received by the communication processor.

In an embodiment, a host website is notified in which the identifying information of the pet is registered with at least the status information, or an indication is provided that the status information has not been received.

In an embodiment, the host website is provided with status information and/or subsequent status information updates regarding the pet via a wireless communication device.

In an embodiment, the identification information is transmitted by the pet tag via a wireless transmitter and received by the communication processor. The pet tag transmits in Bluetooth or Near Frequency Communication (NFC).

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or operations that are illustrated. When the same numeral appears in different drawings, it refers to the same or like components or operations.

FIG. 1 illustrates an overview of a system for dependent welfare and identification, consistent with an illustrated embodiment.

FIG. 2 is a flowchart illustrating the process of providing identifying information and status information regarding a dependent consistent with an illustrated embodiment.

FIG. 3 is a flowchart illustrating the process of providing identifying information and status information regarding a dependent using a QR code, NFC chip, or both, consistent with an illustrated embodiment.

FIG. 4 is a flowchart illustrating the process of providing identifying information and status information regarding a dependent using a tag with a check-in button, fingerprint sensor, or both, consistent with an illustrated embodiment.

FIG. 5 is a flowchart illustrating the process of providing identifying information and status information regarding a dependent using a tag with Bluetooth capability, consistent with an illustrated embodiment.

FIG. 6 is a flowchart illustrating the process of providing identifying information and status information regarding a dependent using a tag with GPS capability, consistent with an illustrated embodiment.

FIG. 7 is a flowchart illustrating the process of providing identifying information and status information regarding a dependent using a tag with a smart camera, consistent with an illustrated embodiment.

FIG. 8 is a flowchart illustrating the process of providing identifying information and status information regarding a dependent using a tag with a smart camera and facial recognition, consistent with an illustrated embodiment.

FIG. 9 is a flowchart illustrating the process of providing identifying information and status information regarding a dependent using an owner/guardian tag consistent with an illustrated embodiment.

FIG. 10 is a flowchart illustrating the process of providing identifying information and status information regarding a pet using a lost pet workflow, consistent with an illustrated embodiment.

FIG. 11 lists certain specifications associated with providing identifying information and status information regarding a dependent consistent with an illustrated embodiment.

### DETAILED DESCRIPTION

### Overview

In the following detailed description, numerous specific details are set forth by way of examples to provide a thorough understanding of the relevant teachings. However, it should be understood that the present teachings may be practiced without such details. In other instances, well-known methods, procedures, components, and/or circuitry have been described at a relatively high level, without detail, to avoid unnecessarily obscuring aspects of the present teachings. The order of operation shown and described in the flowchart(s) are provided for illustrative purposes, and the claimed subject matter is not limited to the order and/or operations shown in the flowchart(s).

As used herein, the term “dependent” is to be interpreted broadly and may be defined as any of a pet, an elderly person, and/or a child. A dependent may also be a patient in a home, hospital, or hospice setting.

As used herein, the term “wireless frequency” is to be interpreted broadly and includes various versions of Bluetooth (e.g. Bluetooth Low energy, etc.), Near Frequency Communication (NFC), 802.11x, Wi-Fi, WiMAX, WiBro, etc., just to name a few non-limiting possible protocols.

As used herein, the term “communication processor” typically includes circuitry configured for operation and in various embodiments includes a server, proxy server, website host server, smartphone, smartwatch, tablet, phablet, smart glasses, etc. The communication processor may also be an app for a mobile communication terminal such as a tablet, smartphone, or smartwatch. The app would be loaded into a smartphone or smartwatch for execution, for example, and operated by the mobile communication terminal.

In the case where the dependent is a pet, a pet tag may be attached or embedded in a dog/cat collar, or may be a microchip that is implanted in/under a pet's skin. While it may be desirable to a transmitter or transceiver, the pet tag may also be an RFID tag, etc. It is to be understood the system and method are not limited in application to dogs and cats. In the case of a dependent person, a wristband, ankle band, arm tag/leg tag may be temporarily adhered to the skin. It is also possible to embed a microchip in a dependent person. In addition, a smartwatch could also be worn by a dependent person with an app activated for this purpose.

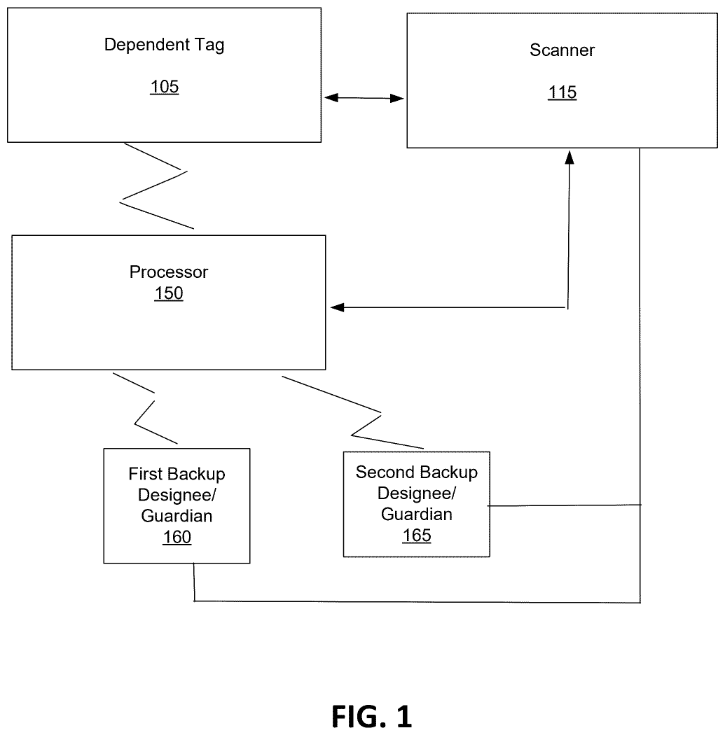

FIG. 1 is an overview of a pet welfare and identification system 100, according to an illustrated embodiment. There is shown a dependent 105, which may contain identifying information regarding the dependent, (and the guardian, family member, nurse, doctor, etc.). In the case where the dependent is a pet, the identifying information may include information about the pet owner, pet's veterinarian, etc.). This identification information may be accessible on a website via smartphone or an app. The pet tag may have a scannable code, such as a bar code, QR code, etc. The term “scannable code” is to be interpreted broadly and may take other forms than QR codes and bar codes.

Alternatively, or in addition thereto, the dependent tag 105 may have a transmitter or transponder, and/or be a microchip implanted in, or on a dependent's skin.

A scanner 115, which may be part of a smartphone, smartwatch, tablet, etc., may be used to scan the dependent tag when it is a scannable code such as a QR code or a bar code. Scanning the QR code may bring up a website with a list of dependents and their identifying information. The website may have registered users, but there may be an option if someone finds a dependent (such as a dog or cat) to scan the tag and notify a pet owner that they are in possession of the pet. In the case of a human dependent who is unable to speak or comprehend sufficiently to communicate, some identifying card or tag may be used for a similar purpose.

A communication processor 150 may be part of a smartphone, smartwatch, tablet, etc. Alternatively, the communication processor 150 may also be a network server, proxy server, etc., that communicates with the scanner device via wireless transmission, including but not in any way limited to Wi-Fi. The communication processor may be configured to check on whether the status information regarding a pet is received within a predetermined time period, and the communication processor may send out reminders to the guardian, family member, pet owner, etc., and/or may contact one or more designees/backup guardians 160, 165 with an alert that the dependent status has not been received. Both the first designee/guardian 160 and the second designee guardian 165, may be contacted successively with the alert. Upon receiving an acknowledgment from the first designee/guardian 160 the communication processor may set a timer to determine if the dependent status has been received. If dependent status is not received, the alert may be sent to a second designee/guardian 165. There may be more than two designees, and they may be contacted in succession or together, to see which designee responds first. For example, when the second guardian designee 165 acknowledges, then the dependent owner and the first designee 160 may receive another message (text and/or email, for example) indicating that the second designee will check on and provide the status of the dependent.

### Method

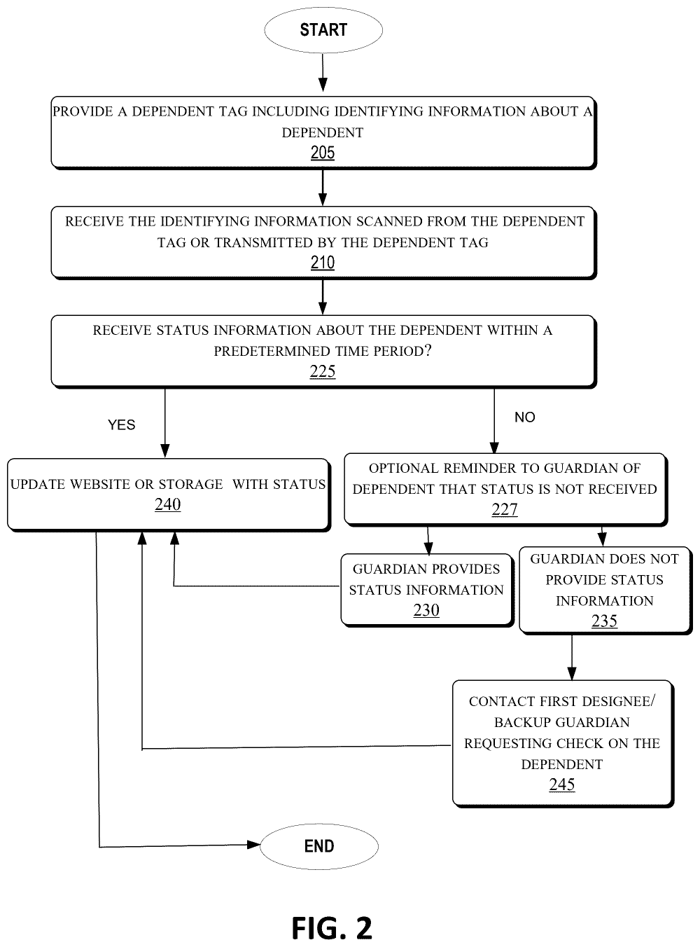

FIG. 2 is a flowchart illustrating according to an embodiment of the present disclosure. With the foregoing overview of the example architecture, it may be helpful now to consider a high-level discussion of an example process. To that end, FIG. 2 is a flowchart of a method of checking pet welfare and identification, consistent with an illustrative embodiment. FIG. 2 is shown as a collection of blocks, in a logical order, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At operation 205, a dependent tag is provided including identifying information about a dependent. This information may be in a scannable code, such as a QR code, bar code, etc., or may be electronically stored on a dependent tag in a transmittable, such as text. As disclosed herein above, the dependent may be a human such as an elderly person, child, incapacitated person, or a pet, just to name some non-limiting examples. It is to be understood that in other embodiments, there may be an owner tag that includes the owner's information.

At operation 210, a communication processor receives the identifying information and status information regarding a condition of the dependent. The communication processor, such as shown in FIG. 1 (element 150) may be a server, tablet, smartphone, smartwatch, etc., just to name some non-limiting examples. The communication processor 150 may communicate with the pet tag via any wireless protocol, including but not in any way limited to Bluetooth, Near Frequency Communication (NFC), 802.11x, Wi-Fi, WiBro, WiMAX, etc. The communication processor 150 is configured to track receipt of the status update including a time elapsed since the last time the status information has been received.

At operation 225, the communication processor determines whether the status information has been received within the predetermined time period. In other words, if there are approximate six-hour intervals, then after six hours have passed the communication processor as to whether the status information was provided. The status information may be provided by the dependent's guardian using, for example, an app, where they tap the touchscreen and check in with an indication that everything is okay. If the status information was received at operation 225, then at operation 240 a website or storage is updated with status. In an alternative embodiment, instead of an app, the dependent's guardian may have logged into a website and provided the status information regarding the dependent.

With continued reference to operation 225, in the event that the status was not received within the predetermined time period, there is an option to send a reminder to the dependent's guardian to request that they send the information as soon as possible. The owner may provide this status information operation (230), and then the website or storage is updated in operation 240. However, if no acknowledgment is received from the dependent's guardian, or a predetermined period has passed without an acknowledgment, then at operation 235 at least the first designee/backup guardian is notified with a request to check on the status of the pet. If the first designee/backup guardian provides the status information (operation 245), the communication processor may begin counting a new time period. Alternatively, the time periods may be fixed in length (e.g., 4 hours, 6 hours) and at such intervals the communication processor will check whether the latest status information has been received. If the first designee does not respond, the communication processor may contact successive designees approximately simultaneously or successively. After updating the website or storage, the method ends until the next time period.

The updating of the website may be performed via cellular transmission, or from another wireless protocol.

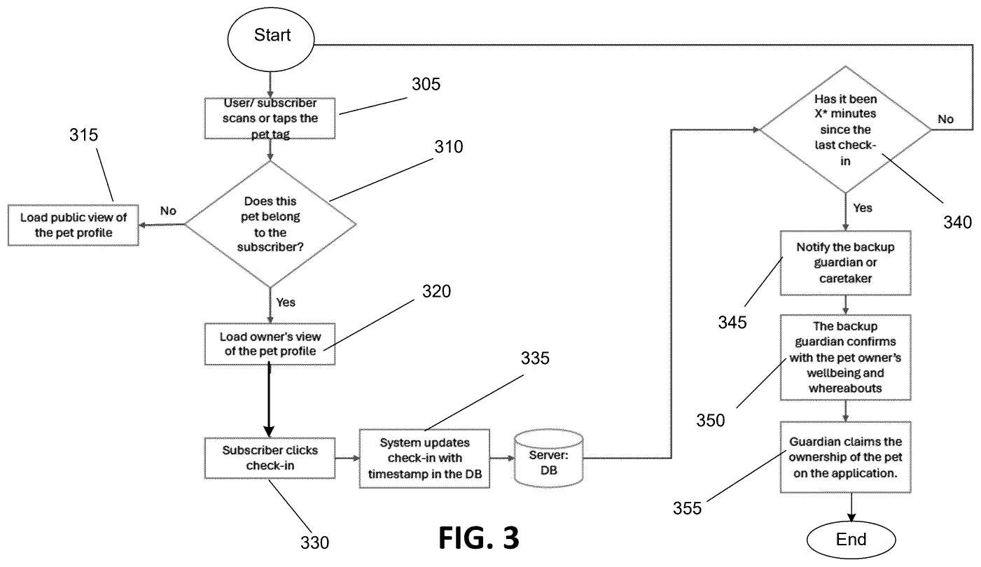

FIG. 3 is a flowchart illustrating the process of providing identifying information and status information regarding a dependent using a QR code, NFC chip, or both, consistent with an illustrated embodiment. In this embodiment, the flowchart refers to a pet tag. However, it is to be understood that the tag is not limited to pets, and may be a dependent tag for people (e.g., elderly, infants, incapacitated, etc.) or for animals that are not pets.

At operation 305, a pet tag is scanned by a user. At operation 310, it is determined whether the pet to which the pet tag has been scanned belongs to the user. If the pet does not belong to the user, a public view of the pet profile is loaded (operation 315). However, if the pet does belong to the user, the owner's view of the pet profile is loaded (operation 320). The user's view of the pet profile may contain more information about the pet, and possibly the user who in this case may be an owner. The user (e.g., subscriber) clicks a check-in (operation 330) and the system updates the check-in with a timestamp in the database (operation 335). It is then determined with whether a predetermined number of minutes has passed since the last check-in (operation 340). If not, the workflow returns to the start and may begin with operation 305 again. However, if at operation 340 there has been a sufficient amount of time (e.g., minutes) since the last check-in, the backup guardian or caretaker is notified (operation 345). At operation 350, there is a confirmation received by the backup guardian regarding the pet owner's well-being and whereabouts. At operation 355, the guardian claims the ownership of the pet listed on the application and the method ends. In the aforementioned illustrative example, the backup guardian, rather than the guardian, was the one confirming the well-being and whereabouts of the pet.

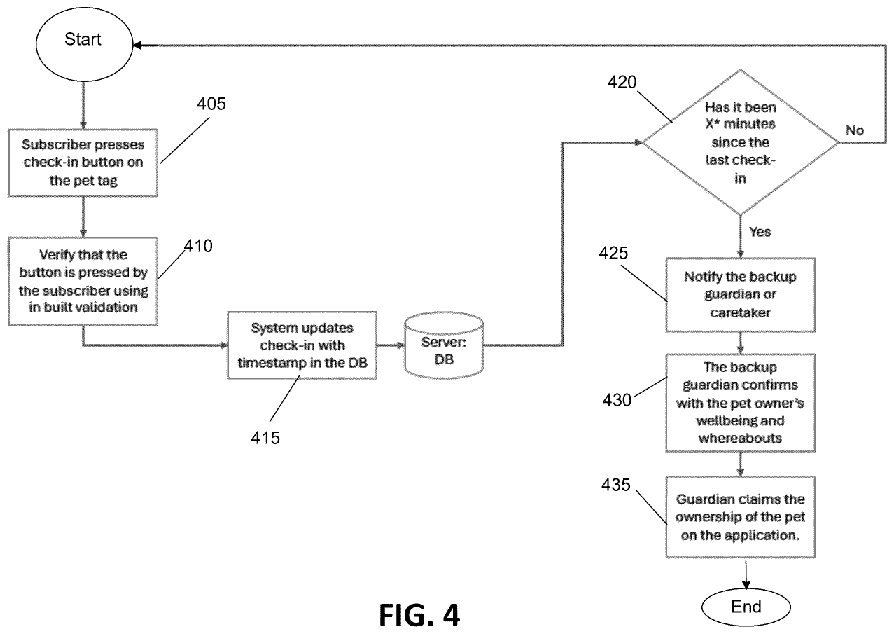

FIG. 4 is a flowchart illustrating the process of providing identifying information and status information regarding a dependent using a tag with a check-in button, fingerprint sensor, or both, consistent with an illustrated embodiment. In this illustrative embodiment, there is a precondition that each tag is linked with a pet profile. At operation 405, a user/subscriber presses a check-in button on the pet tag. There may be a validation that the button is pressed by the user/subscriber (e.g. fingerprint identification, etc. (operation 410). The system updates the check-in with a timestamp in the database (operation 415). Thus, this pressing of the check-in button, which can be performed by the owner, dog sitter, dog walker provides a status about the well-being and/or whereabouts of the pet. Operations 420, 425, 430, and 435 are similar to operations 345, 350, and 355 illustrated and discussed with regard to FIG. 3.

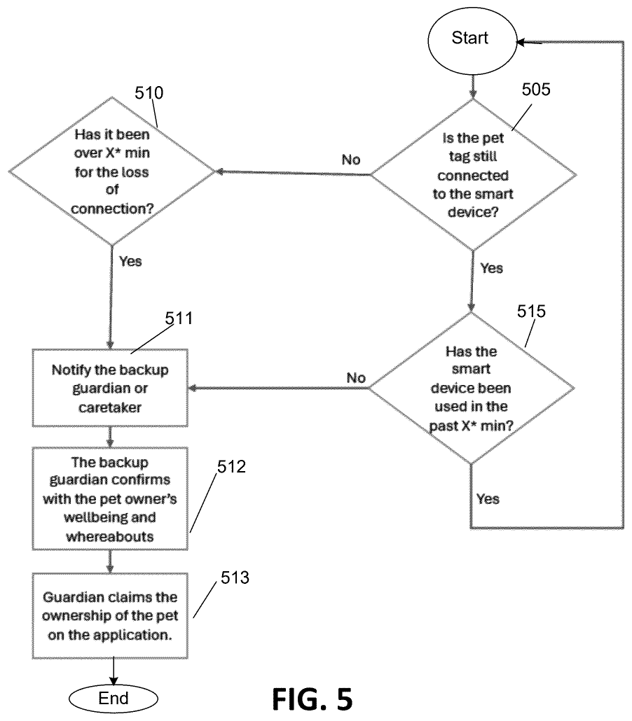

FIG. 5 is a flowchart illustrating the process of providing identifying information and status information regarding a dependent using a tag with Bluetooth capability, consistent with an illustrated embodiment. A precondition in FIG. 5 is that a user/subscriber has a mobile app loaded onto their smartphone, smartwatch or other device, and a Bluetooth tag for their pet is connected and linked. At operation 505 it is determined whether the pet is still connected to the smart device (operation 505). If the pet tag is still connected, then it is determined whether the smart device has been used within a predetermined period of time (e.g., minutes) (operation 515). However, if at operation 505 the pet tag is not connected to the smart device, first at operation 510 it is determined if a predetermined time period has passed since the loss of connection was detected. At operation 511 the backup guardian or caretaker is notified if the determination at operation 510 is that the predetermined time period has been reached. At operation 512 the backup guardian confirms with the pet owner the well-being and whereabouts of the pet (operation 512). Then at operation 513 the guardian claims the ownership of the pet on the application, and the method ends.

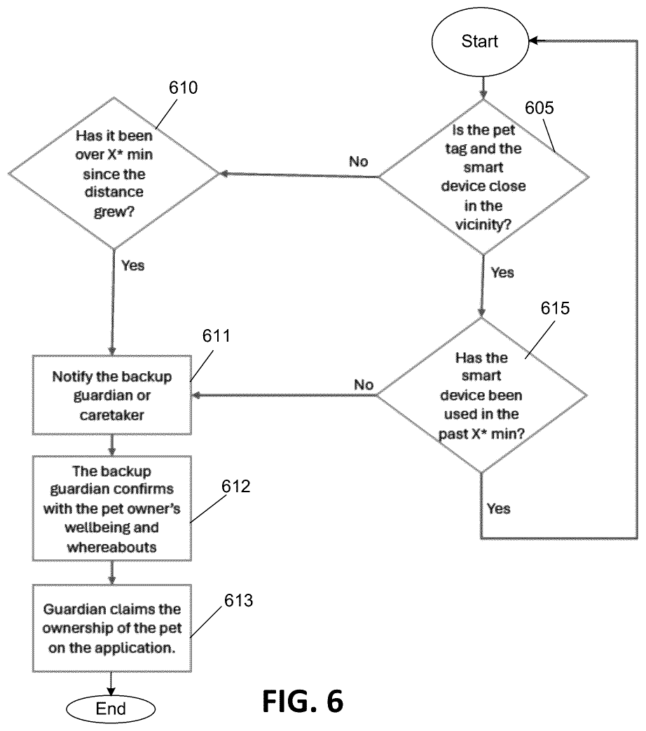

FIG. 6 is a flowchart illustrating the process of providing identifying information and status information regarding a dependent using a tag with GPS capability, consistent with an illustrated embodiment. A precondition is that a user/subscriber has a mobile app loaded onto their smartphone, smartwatch or other device, and a GPS tag is linked to the pet profile. It is first determined at operation 605 if the pet tag and the smart device are within a predetermined vicinity (e.g., the pet may be outside the house in a yard, and the user with a smart device may be inside the house, so there is a range of distance that would be considered proximate. If the determination at operation 605 is affirmative, then it is determined if the smart device has been used within a predetermined time (e.g., minutes) (operation 615). If the smart device has been used, then the method goes back to the beginning for a periodic reperformance of operation 605. However, if at operation 615 the smart device has not been used within a predetermined time period, or if at operation 610 it has been over a predetermined time period since the distance between the pet tag and the smart device grew, then operations 611, 612 and 613 are performed. The operations 611, 612, and 613 are similar to the operations 511, 512 and 513 discussed regarding the flowchart shown in FIG. 5.

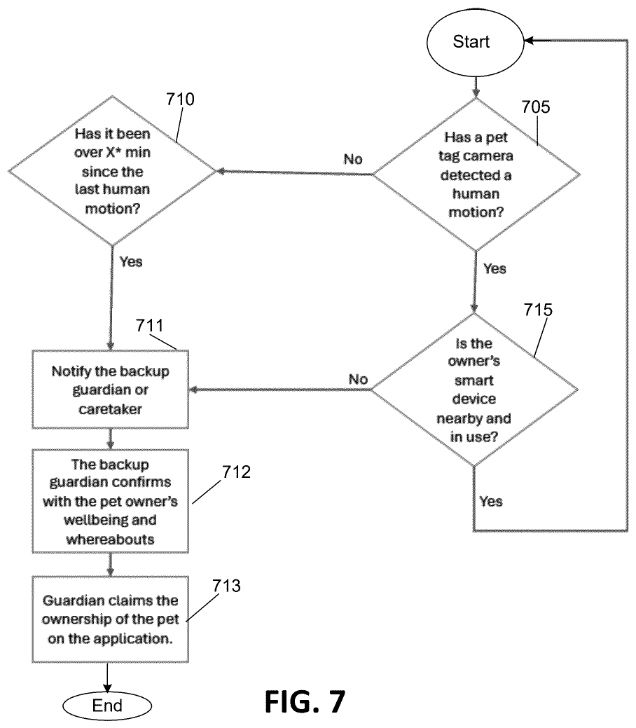

FIG. 7 is a flowchart illustrating the process of providing identifying information and status information regarding a dependent using a tag with a smart camera, consistent with an illustrated embodiment. A precondition of this illustrative embodiment is that a user/subscriber has a mobile app loaded onto their smartphone, smartwatch or other device, and a pet tag with a smart camera is linked to the pet profile. The camera may also record and save the pet's point of view, for example, on the cloud. At operation 705, it is determined with a pet camera that human motion has been detected. If the human motion has been detected, then at operation 715 it is determined whether the owner's smart device is nearby and in user. If operation 715 is affirmative, the method reverts to operation 705 again. However, if the response to operation 715 is negative, or in the case of operation 710, where it is determined there has been more than a predetermined period of time (e.g. minutes) since the last human motion, then operations 711, 712, and 713 are performed. The operations 711, 712, and 713 are similar to operations 511, 512, and 513, respectively as discussed herein above with regard to FIG. 5.

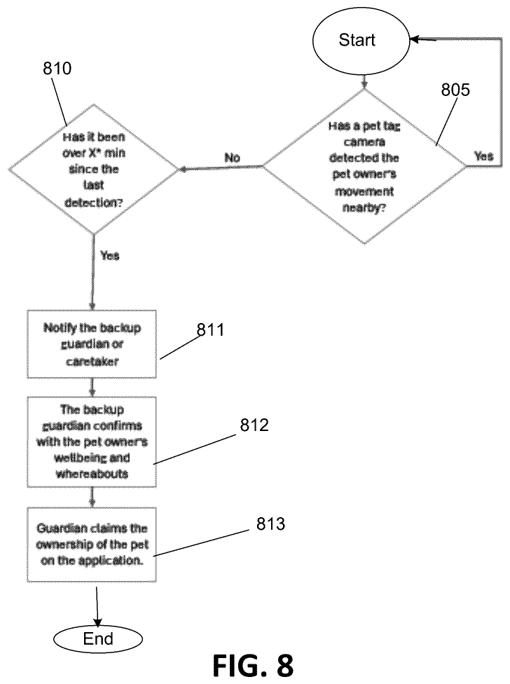

FIG. 8 is a flowchart illustrating the process of providing identifying information and status information regarding a dependent using a tag with a smart camera and facial recognition, consistent with an illustrated embodiment. A precondition of this illustrative embodiment is that a user/subscriber has a mobile app loaded onto their smartphone, smartwatch or other device, and a pet tag with a smart camera is linked to the pet profile. The user/subscriber has registered their facial recognition on the app. At operation 805 it is determined whether the per tag camera has detected the pet owner's movement nearby. The pet owner is recognized via facial recognition. If operation 805 is affirmative, the method periodically restarts to check for the owner's motion. If at operation 810 it is determined there has been more than a predetermined period of time (e.g. minutes) since the last detection of the pet owner's motion, then operations 811, 812, and 813 are performed. These operations 811, 812, and 813 are similar to operations 511, 512, and 513, respectively as discussed herein above with regard to FIG. 5.

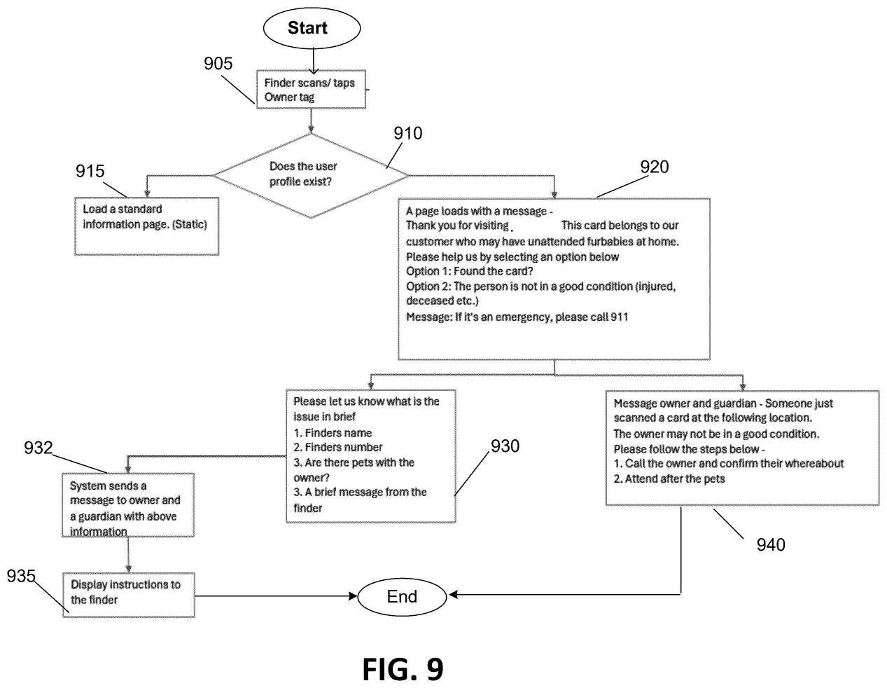

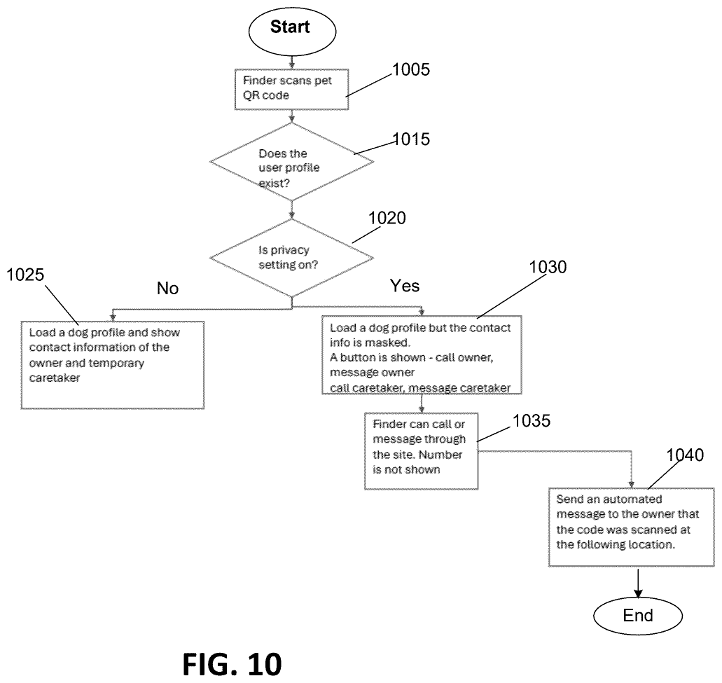

FIG. 9 is a flowchart illustrating the process of providing identifying information and status information regarding a dependent using an owner/guardian tag consistent with an illustrated embodiment. The tag used in the illustrative embodiment is not a pet tag, but rather an owner tag. A notification is made to the backup guardian if something happens to the pet owner so that the pet is always looked after. A precondition is that a user/subscriber gets a card/tag with a QR code, NFC tag, or both. In other words, in this illustrative embodiment, this tag is not a pet tag, but a pet-owner tag. At operation 905, the pet owner tag is tapped. The tap may be made by someone who found the dependent (e.g. pet). At operation 910 it is determined if a user profile exits. If there is no profile, at operation 915 a static information page is loaded and information can be entered and/or displayed. If a profile exits, at operation 920 a page loads with a message and options regarding whether the card (or tag) was found, and options about the dependent and whether they are injured, sick, etc. At operation 930, the person who tapped the tag (the person who found the pet) is prompted to enter their name, number, question of there are other pets, and any brief message to assist with reuniting the pet with its owner. At operation 932 the system sends a message to the owner of the pet and a guardian with the information from the person who found the pet. Then at operation 935 the instructions are displayed to the finder. Alternatively, at operation 940 the owner and guardian may both receive a message that someone activated a tag or scanned a card regarding the pet. The message may also provide a location, as well as additional instructions for the guardian to contact the owner, who may not be well. FIG. 10 is a flowchart illustrating the process of providing identifying information and status information regarding a pet using a lost pet workflow, consistent with an illustrated embodiment. The lost pet workflow is operational with all variations as discussed herein above. Each pet has a tag with a QR code, NFC tag, or both. The link has all the pet's information as well as the owner's information. In the case of a GPS tag, the owner can locate the pet in real-time. In the case of Bluetooth, the user/subscriber can locate the tag using a nearby smart device location. Smart devices that are within a predetermined distance of the lost pet will get an alert notifying that a lost pet is nearby. This alert will include a link to the pet's profile and to the owner, so that a nearby person can notify the owner. It is also possible for the nearby smart device to use the information and generate a message notifying the owner without any intervention by a person nearby (generated automatically). At operation 1005, a pet (or person) finder scans a QR code that is attached to the pet. At operation 1015, the system determines whether a profile exists and whether a privacy setting is on (operation 1020). If there is no privacy setting, the dog profile and the contact information of the owner and a temporary caretaker are displayed. If there is a privacy setting on, the dog profile is loaded but the contact information of the owner is masked. A button may be displayed that when activated calls or sends a message to the owner, caretaker, etc. (operation 1030). At operation 1035 the finder can call or message the owner through the site hosting the application instead of direct contact with the owner. At operation 1040 an automated message is sent to the owner that the code for their pet was scanned at a specific location that is displayed. In this way, the owner and their pet can be reunited.

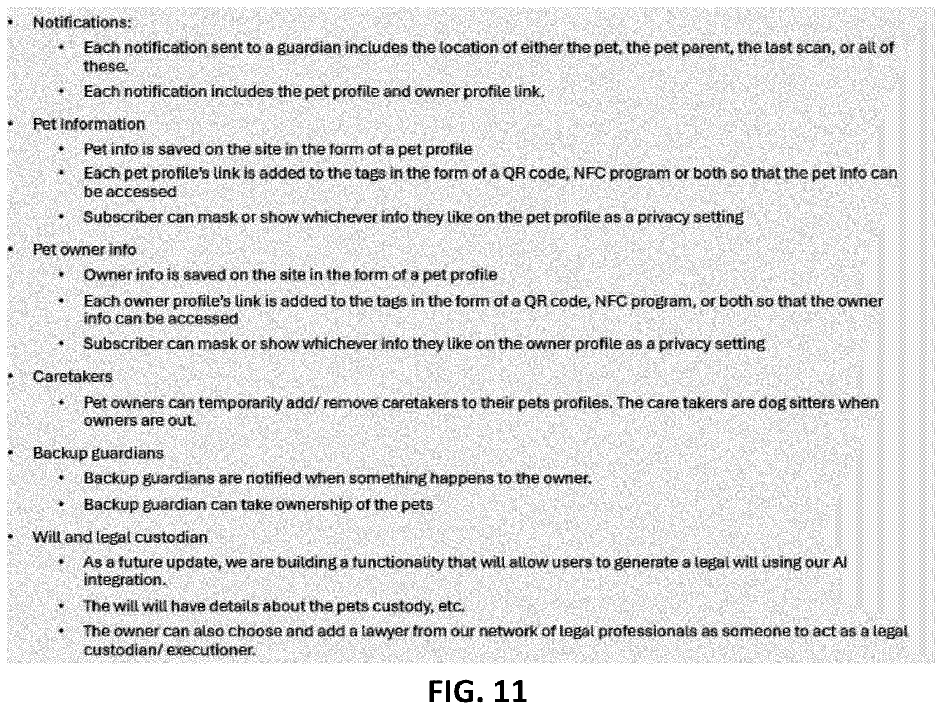

FIG. 11 is a list of the process of certain specifications associated with providing identifying information and status information regarding a dependent consistent with an illustrated embodiment. FIG. 11 lists the notifications that may be made to pet owners, guardians, backup guardians, the ASPCA, or animal control, and to identify a legal custodian (a pet will) in the event the owner becomes deceased or incapacitated.

### CONCLUSION

It is to be understood that all of the illustrative embodiments that refer to pets are also applicable to persons, etc. The descriptions of the various embodiments of the according to present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments of the disclosure are also contemplated. There are also embodiments of the disclosure in which the components and/or operations are arranged and/or ordered differently than described and shown herein.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

What is claimed is:

1. A dependent welfare and identification system, comprising:
a dependent tag including identifying information about a dependent;
a communication processor configured to receive the identifying information and a status information regarding a condition of the dependent and/or a proximity of the dependent to a guardian; and
wherein the communication processor is further configured to notify at least one designee after a predetermined time period has passed without receiving at least the status information.

2. The dependent welfare and identification system according to claim 1,
wherein the communication processor comprises a server, and wherein the identifying information and status information about the dependent is received from a mobile communication terminal.

3. The dependent welfare and identification system according to claim 2, wherein the server is configured to communicate with a host website in which the identifying information of the dependent is registered.

4. The dependent welfare and identification system according to claim 3, wherein the dependent comprises a pet.

5. The dependent welfare and identification system according to claim 4, wherein the server is further configured to provide the host website with status information and/or subsequent status information updates.

6. The dependent welfare and identification system according to claim 1, wherein the communication processor comprises a smartphone app.

7. The dependent welfare and identification system according to claim 6, wherein the communication processor generates an alert that is wirelessly transmitted to the at least one designee after a predetermined time period has passed without receiving at least the status information.

8. The dependent welfare and identification system according to claim 7, wherein when the at least designee comprises two or more designees, the communication processor transmits the alert to the two or more designees at the same time or in succession until one of the two or more designees acknowledges receipt of the alert.

9. The dependent welfare and identification system according to claim 1, wherein the communication processor comprises a smartphone or smartwatch.

10. The dependent welfare and identification system according to claim 9, wherein the dependent tag includes a wireless frequency transponder to communicate with the smartphone or smartwatch via at least one of Bluetooth, WiFi, Wi-Bro, WiMax.

11. The dependent welfare and identification system according to claim 10, wherein the dependent tag includes a transmitter configured to output information in Bluetooth or Near Frequency Communication (NFC).

12. The dependent welfare and identification system according to claim 1, wherein the identifying information is stored on the dependent tag as a scannable code.

13. The dependent welfare and identification system according to claim 1, wherein the identifying information is stored on the dependent tag as a QR code or bar code, and further including a camera to record a pet's point of view and provide a visual location.

14. The dependent welfare and identification system according to claim 12, wherein the communication processor is further configured to
output a dependent profile to a display in response to detecting the dependent tag has been scanned by a mobile communication device;
receive a check-in status periodically and update a storage with the latest status information; and
generate an alert to notify the at least one designee after the predetermined time period has passed without receiving at least the status information.

15. The dependent welfare and identification system according to claim 12, wherein the communication processor, wherein the communication processor comprises a smartphone or smartwatch further configured to
output a dependent profile to a display in response to detecting activation of a touchscreen;
receive a check-in status periodically and update a storage with the latest status information; and
generate an alert to notify the at least one designee after the predetermined time period has passed without receiving at least the status information.

16. The dependent welfare and identification system according to claim 12, wherein the smartphone or smartwatch generates at least one text message or one email to the at least one designee when a predetermined period time period has elapsed without receiving an update status information.

17. The dependent welfare and identification system according to claim 12, wherein the smartphone or smartwatch generates at least one audible alert, tactile alert, or visual alert as a reminder that updated status information regarding the dependent has not been received.

18. A method of checking a pet's welfare and identification, the method comprising:
providing a dependent tag including identifying information about a dependent;
receiving, by a communication processor, the identifying information and a status information regarding a condition of the dependent, and
notifying at least one designee after a predetermined time period has passed without receiving at least the status information;
wherein the providing of identification information is wirelessly transmitted by the dependent tag, or the dependent tag includes scannable code that is read and received by the communication processor.

19. The method according to claim 18, further comprising:
notifying a website in which the identifying information of the dependent is registered with at least the status information, or an indication is provided that the status information has not been received.

20. The method according to claim 19, wherein the website is provided with status information and/or subsequent status information updates regarding the dependent via a wireless communication device.

21. The method according to claim 18, further comprising:
receiving the identification information transmitted by the dependent tag via a wireless transmitter; and
wherein the dependent tag transmits in Bluetooth or Near Frequency Communication (NFC).

22. The method according to claim 18, wherein the providing of the dependent tag comprises providing a pet tag a including identifying information about a pet.
